(19) United States
(12) Patent Application Publication
(10) Pub. No.: US 2014/0229487 A1
(43) Pub. Date: Aug. 14, 2014

(54) SYSTEM AND METHOD FOR USER PREFERENCE AUGMENTATION THROUGH SOCIAL NETWORK INNER-CIRCLE KNOWLEDGE DISCOVERY

(71) Applicants: Smruthi Mukund, Sunnyvale, CA (US); Venugopal Govindaraju, Williamsville, NY (US); Anurag Bhardwaj, Sunnyvale, CA (US); Achint Oommen Thomas, Sunnyvale, CA (US); Srirangaraj Setlur, Getzville, NY (US)

(72) Inventors: Smruthi Mukund, Sunnyvale, CA (US); Venugopal Govindaraju, Williamsville, NY (US); Anurag Bhardwaj, Sunnyvale, CA (US); Achint Oommen Thomas, Sunnyvale, CA (US); Srirangaraj Setlur, Getzville, NY (US)

(73) Assignee: The Research Foundation of State University of New York, Amherst, NY (US)

(21) Appl. No.: 14/119,202

(22) PCT Filed: Jun. 13, 2012
(86) PCT No.: PCT/US2012/042333

§ 371 Date: Mar. 24, 2014

Related U.S. Application Data
(60) Provisional application No. 61/496,295, filed on Jun. 13, 2011.

(51) Int. Cl. G06F 17/30

(52) U.S. Cl. CPC G06F 17/30861; G06F 17/30598
USPC 707/740; 707/748; 707/736

(57) ABSTRACT

A system and method are disclosed for user preference augmentation through social network inner-circle knowledge discovery. A user's activity may be captured allow a user preference model to be created. The user preference model is compared to other models in the user's social network. A inner-circle social network is created, and the user preference model is augmented based on other preference models in the inner-circle social network, and the user's own preference for certain categories of information element. Information elements can be provided to the user based on suggestions and the user's preference model. The information elements may be organized such that the more relevant information elements are more easily accessible to the user.

### CROSS-REFERENCE TO RELATED APPLICATION

This application claims the benefit of priority to U.S. provisional patent application Ser. No. 61/496,295, filed on Jun. 13, 2011, now pending. The disclosure of the above priority document is incorporated herein by reference.

### FIELD OF THE INVENTION

The present invention relates to the field of knowledge discovery, namely, knowledge discovery through inner-circle social networks.

### BACKGROUND OF THE INVENTION

The ease of publishing and posting information electronically, especially on the Internet, has led to a tremendous growth of stored information. Never before has so much information been recorded and disseminated throughout the world. As the amount of stored and archived information expands, it becomes more and more difficult to sift meaningful information from the extraneous “noise.”

Somewhere within this massive amount of information, exists information elements that may cater to a wide spectrum of users from diverse age groups and different backgrounds. However, an information element that may be of great value to one user may be a waste of time to another. As such, finding the right piece of information among the massive confluence of the Internet is as daunting as finding a needle in a haystack. Collected data may comprise a mixture really interesting information elements, appealing information elements, and junk information elements from the user's perspective. Currently, the user is then required to manually shuffle through the information elements to decide what to read and what not to read. This may be time consuming and frustrating. The present invention is designed to overcome this frustration. It aims to present to the user only those information elements that satisfy the reader's information need.

Recent advances in information retrieval and search techniques have enabled users to mine relevant information effortlessly; however, such techniques are generic and are focused on satisfying the needs of a group of users, not an individual user. Therefore, there is a need for a system and/or method to assist individuals with locating knowledge and information, particularly information that is more personalized to the individual's needs.

### SUMMARY OF THE INVENTION

The mining of relevant information for every user is a non-trivial problem. However, a user's social network is a very strong and useful constraint in which search criteria can be refined, thereby maximizing the chance of finding the most relevant information in a minimum amount of time. The present invention is based on this principle of social networking, which can illustrate a particular user's likes and dislikes, what kind of information the user is interested in, and how the user interacts with other users that have differing or similar information needs. These particular social behaviors may help focus searches on the proper topics and allow users to discover useful information which the user would not have previously been able to find.

The present invention allows for a unique social experience that serves as a small window to the Internet. This window regulates the information flow to each user, so that the user can discover, grasp, and enjoy relevant information element in the stream instead of being bombarded with irrelevant information elements published in rapid succession. The present invention is a unique combination of relevance based information system and social networking which forms a potent knowledge discovery tool for the Internet. It allows users to connect with other users over a virtual social network. Each user may have a unique identity but share common interests and information needs. This virtual network representation is built on top of the physical network of users, where a user may be connected to a thousand others physically, but have an intersection of ideas and relevance with a limited few. In other words, the present invention allows a user to discover a knowledge-similar virtual network on a user's social network and uses this virtual network to harvest relevant information for the user to satisfy the user's information needs.

The invention may be embodied as a method for providing a user with organized information elements. The user may have a social network comprising a plurality of associates, each associate having an associate preference model. Each associate preference model may comprise a plurality of subject categories. The method may comprise the step of capturing user feedback data by monitoring the user's activity.

The method may further comprise creating a user preference model based on the user's feedback data. In one embodiment, creating the user preference model further comprises the sub-steps of creating a default user preference model and augmenting the default user preference model based on the monitored user activity.

The user preference model may comprise a plurality of subject categories. In one embodiment, information elements are mapped to one or more of the subject categories. In another embodiment, the user or users selects to which category the information elements are mapped.

The subject categories of at least one associate preference model may be compared to the subject categories of the user preference model. An inner-circle social network is created, based on the comparison of subject categories, the inner-circle social network comprising the user and one or more of the associates;

The method may further comprise the step of augmenting the user preference model based on the associate preference models from the inner-circle social network. A user may be provided with suggested information elements based on information elements consumed by associates in the inner-circle social network. The user preference model may be augmented based on the user's response with respect to each suggested information element.

The method may further comprise organizing at least some of the information elements based on the user's preference model, wherein the information elements are organized such that information elements relevant to the user are more accessible to the user.

The method may further comprise providing the user with organized information elements based on the user's preference model, wherein the information elements are organized such that information elements relevant to the user are more accessible to the user. In one embodiment, the information elements are also organized based on a sliding scale between relevance to the user and information element publication date. In another embodiment, the user can indicate the relevance of each information element. In one embodiment, the information elements are also organized based on a relevance of each information element to the user and a publication date for each information element, wherein the weight given to the relevance and publication date are adjustable.

The method may further comprise the steps of adding an associate to the user's social network and augmenting the user's preference model based on the associate preference model of the added associate.

The method may further comprise the step of mapping information elements further comprises the sub-step of receiving from the user a selection of one or more subject categories to which information elements should be mapped.

The invention may also be embodied as a system comprising a server, a first, second, and third database, a processor, and a display device.

The server may be capable of retrieving information elements from the Internet. The servers may comprise an information element cleanup module and a natural language pre-processing module. In one embodiment, the server may be a cloud based service.

The first database may be in communication with the server. The first database may comprise attributes associated with each information element. The second database may be in communication with the server, the second database comprising indexed information elements transformed by the natural language pre-processing module. The third database may comprise user preference models.

The processor may be in communication with the first, second, and third databases. The processor may be configured to evaluate indexed information elements based on a user preference model in the third database, and recommend a subset of the information elements to a user.

The display device may be in communication with the third database and the processor. The device may be configured to display the subset of the indexed information elements and receive user input regarding each information element. In one embodiment, the display device may be a mobile device.

The present invention may also be described as a method for providing a user with organized information elements and information element suggestions. In this method, the user may have a user preference model. The method may comprise the step of monitoring information sources that provide information elements. Information elements may be retrieved from the information sources. In one embodiment, the retrieved information element has a link and a timestamp. A unique identifier may be assigned to each information element. In another embodiment, each unique identifier may be a hashed output of the information element's link and timestamp;

The method may further comprise the step of assigning tags to each information element. The unique identifiers and the tags associated with each information element are stored in a first database. The information elements may be stored in a second database, such that the information elements are accessible by the unique identifier. The information elements may be indexed by calculating user-specific score for each information element. The element-specific score may be based on the user's preference model and the tags assigned to each information element. In one embodiment, the user has a social network and the element-specific score for the user is also based on the user's social network.

The method may further comprise the step of providing the user with organized information elements and information element suggestions based on the element-specific score calculated for each information element. In one embodiment, the organized information elements are provided to an display device. In another embodiment, a display device is provided with unique identifiers for organized information elements such that the display device is capable of retrieving the information elements from the second database.

In one embodiment, the method may further comprise the step of organizing at least some of the information elements based on the user's preference model, wherein the information elements are organized such that information elements relevant to the user are more accessible to the user.

The present invention may also be embodied as a system comprising a processor, an information element cleanup module, a natural language pre-processing module, a database, and a client device.

The processor may be configured to retrieve information elements. The information element cleanup module and the natural language pre-processing module may both be in communication with the processor. The processor may also be configured to indexed information elements based on a user preference model and determine a subset of the information elements relevant to a user based on the evaluation

The database may also be in communication with the processor. The database may comprise attributes associated with each information element, indexed information elements processed by the natural language pre-processing module, and user preference modules.

The client device may be in communication with the database and the processor. The client device may be configured to receive the determined subset of information elements, display the subset of information elements, and receive user input regarding each information element of the subset.

One exemplary embodiment of the present invention may be a system for automatically building a user's personalized profile for knowledge discovery. Some characteristics of this embodiment are: capturing user feedback by monitoring user activity as the user consumes information in order to build a stand-alone user-knowledge preference model; building a virtual, trusted, inner-circle network of users based on a category level user-to-user similarity from the user's existing social network; augmenting the user-knowledge preference model by including model parameters discovered from the influence of a user's trusted inner-circle network influencers; triggering the user's information interests by suggesting to the user information consumed by his trusted inner circle social peers; organizing available information (on the Internet) to the user in a way that the user will spend less time searching for relevant information and more time consuming relevant information; and, augmenting the user-knowledge preference model by extracting features/estimating parameters obtained by monitoring his activity on exclusively shared information items among his social peers.

### BRIEF DESCRIPTION OF THE DRAWINGS

For a fuller understanding of the nature and objects of the invention, reference should be made to the following detailed description taken in conjunction with the accompanying drawings, in which:

FIG. 1 is a layout of an information element viewing screen according to one embodiment of the present invention;

FIG. 2 is a flowchart depicting the retrieval of information elements according to one embodiment of the present invention;

FIG. 3 is a diagram depicting the storage of information elements in a database and the association of the information elements to corresponding features according to one embodiment of the present invention;

FIG. 4 is a flowchart depicting one embodiment of the present invention;

FIG. 5 is a diagram depicting one embodiment of the present invention;

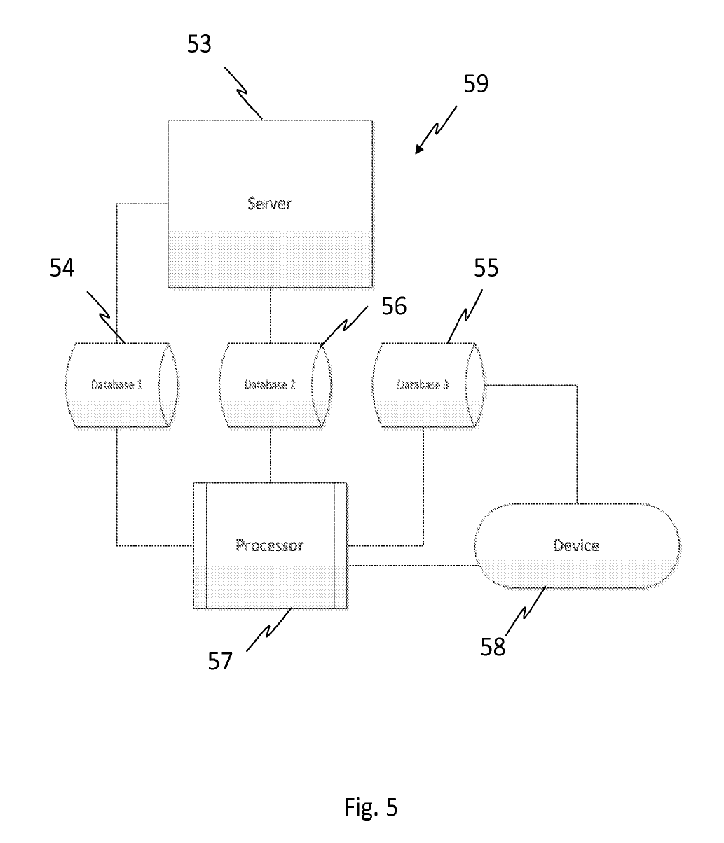

FIG. 6 is a diagram depicting another embodiment of the present invention; and

FIG. 7 is an image of layout of an information element viewing screen according to one embodiment of the present invention.

### FURTHER DESCRIPTION OF THE INVENTION

The present invention may be embodied as a method for providing a user with organized information elements. Generally, a user refers to an individual, however a user may also refer to a group of people, an organization, or a virtual user (such as a computer program or algorithm) The user will have a social network. A social network may be represented as a mathematical graph comprising a user and their associates (other individuals or organizations) which are connected by one or more specific types of interdependency, such as friendship, common interest, financial exchange, dislike, relationships, etc. A social network may comprise a representation of each user (often a profile), his/her social links, and a variety of additional services. Most social networks are web-based and provide means for users to interact over the Internet, such as e-mail and instant messaging. A social network may allow users to share ideas, activities, events, and interests within their individual networks.

The social network may comprise the user and a plurality of associates. Each associate may have an associate preference model. An associate preference model may contain a textual or numerical representation of an associate's characteristics, for example, their likes and dislikes.

The associate preference model may change over time, through the associate's actions, through the associate's interdependencies, or the alteration of those dependencies. The associate preference model may also comprise a plurality of subject categories. These categories may relate to certain topics, formats, content, or style. The subject categories may also describe a genre (e.g. sports, national news, entertainment, elections, etc.). The associate preference model may indicate the associate's preference or dislike of certain categories or genres.

Information elements may include, but are not limited to, e-mails, messages, documents, spreadsheets, files, letters, news articles, blog postings, comments, photos, videos, infographs, or a combination of these items.

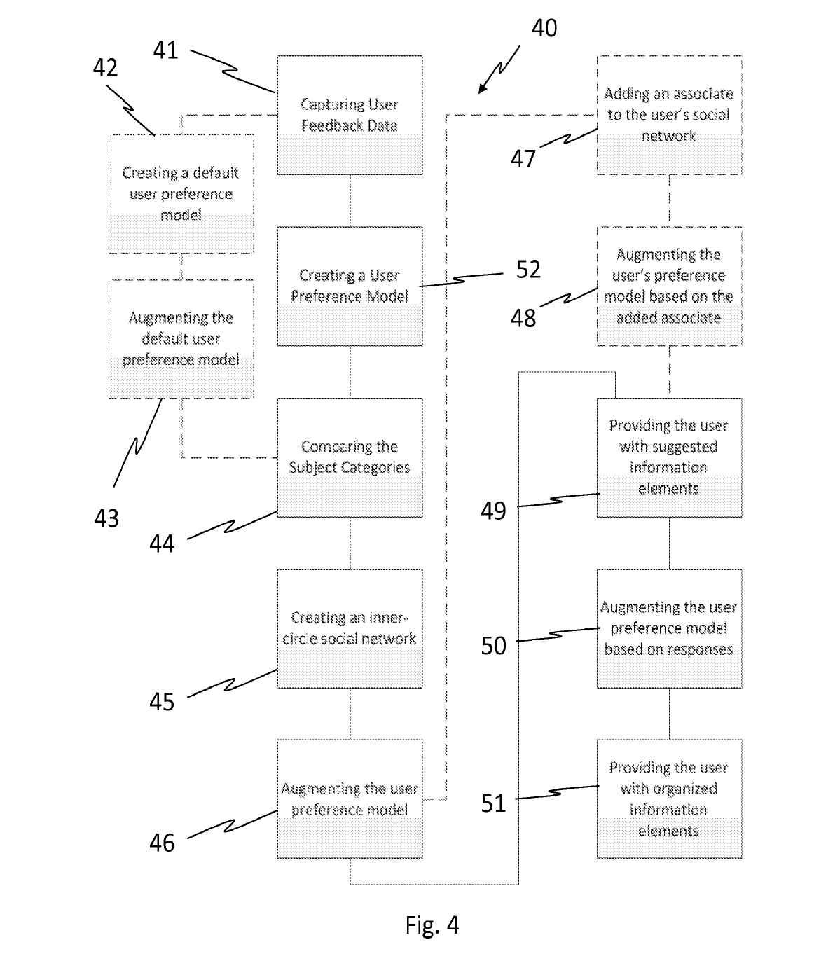

FIG. 4 depicts a method 40 in keeping with the present invention. The method 40 for providing a user with organized information elements may comprise several steps. In one embodiment, the method 40 comprises the step of capturing 41 user feedback data by monitoring the user's activity. User activity may include electronic activity. For example, electronic activity may include browsing the Internet, sending and receiving e-mail, instant messaging, reading news items, viewing movies, listening to music, uploading photographs, etc. In this example, the user feedback data may include standard web analytics, such as time spent on a website, commonly accessed websites, and user movement between websites. User activity may also include a user's intentional actions, such as sharing an information element with others, approving or disapproving ratable content, deleting or archiving messages, and items purchased or sold online. User activity may also include physical activity, such as purchases made in retail stores, household consumption, and other demographic information. User feedback data may comprise a combination of both electronic and physical user activity.

Feedback data may be captured using a server or other computing device configured to monitor a user's computer use. For example, feedback data may be captured using a tracking cookie in an Internet browser so the user's website browsing activity is tracked. Feedback data may also be collected on a server hosting information elements. Other devices used to capture electronic feedback data may be electronic surveys, indexing of e-mail correspondence, or other user-initiated submissions. The user's activity may be monitored continuously, at regular intervals, irregular intervals, or only by user request. The data captured by a server or other computing device may need to be processed, or transformed, by a computer such that the data can be processed as feedback data by the present invention.

The method 40 may comprise the step of creating 52 a user preference model based on the user's feedback data, the user preference model comprising a plurality of subject categories. The user preference model may be created 52 by creating 42 a default template (e.g., where the user has no likes or dislikes for certain categories) and augmenting 43 the default user preference model based on the user's activity, for example, the monitored user activity. The user preference model may be created 52 from a predetermined template with non-neutral default values. In one embodiment, the user preference model may be structured similarly to the associate preference model. In this way, all preference models are treated identically for computational simplicity. Information elements may be mapped to these categories. For example, an information element in the form of a news article may be mapped to one or more categories (e.g., a news story about high-tech racing technology may be mapped to an automotive category, a sporting category, and a technology category). The user or the user's associates may determine the mapping of an information element to one or more categories. This can be done manually, or an algorithm may suggest which categories an information element is mapped to, whereby the users and associates confirm the algorithm's selection. The mapping may be determined by a single user or a combination of one or more users with or without their associates.

The method 40 may comprise the step of comparing 44 the subject categories of at least one associate preference model to the subject categories of the user preference model. The comparison 44 may be numerical in nature (e.g., identifying categories with similar or dissimilar numerical scores), or textual in nature (e.g., identifying categories with similar or dissimilar descriptors). A descriptor, for example, could be an adjective that describes a user's or associate's preference toward a certain category (e.g., excited, ambivalent, boring, etc.)

The method 40 may comprise the step of creating 45 an inner-circle social network. The inner-circle social network may be a subset of the user's social network. As such, the inner-circle social network may comprise the user and one or more of the associates from the user's social network. Associates may be chosen for inclusion in the inner-circle social network based on the comparison of subject categories between the user and the associate. In one embodiment, only associates with high subject category correlations are included in the inner-circle social network. In other embodiments, associates are chosen not only by correlation, but also by disassociation. For example, it may be beneficial to include an associate in a user's inner-circle social network with a high positive preference in a specific category in order to supplement a neutral, or negative preference in the user's preference model. In other embodiments, the user may be able to select which associates are included in a created 45 inner-circle social network.

The method 40 may comprise the step of augmenting 46 the user preference model based on the associate preference models from the inner-circle social network. In one embodiment, the user's preference model may be augmented 46 based on the associates selected for inclusion in the inner-circle social network. For example, if a user has many associates with a positive preference category in their respective associate preference model, the user's preference model may increase the preference for the same categories (e.g., if a user's associates have high preference values for computers, the user's preference value for computers may be increased, or vice versa). The user's preference model may be augmented 46 based on the addition 47 or removal of associates. For example, if the user begins to add associates from the inner-circle social network, the user's preference model may be augmented 48 based on the user's reason for removal. The associated-change augmentation 48 may occur simultaneously, or separately from, the augmentation 46 based on the associate preference models from the inner-circle social network.

The method 40 may comprise the step of providing 49 the user with suggested information elements based on information elements consumed by associates in the inner-circle social network. A user may be provided 49 with information elements electronically or physically. For example, a user may be provided 49 with suggested information elements through a newsletter, electronic digest, or both. The user may receive links, such as hyperlinks, that direct the user to an information element. A system providing links would not need to transmit or deliver the entire information element, thereby reducing transaction costs. In one embodiment, the user may be provided 49 with a suggested information element that an associate has consumed. The associate may actively indicate that this information element should be shared among their inner-circle social network, or the information element may be shared without their explicit authorization. In some embodiments, the user can indicate the relevance of each information element as perceived by the user.

The method 40 may also comprise the step of augmenting 50 the user preference model based on the user's response with respect to each suggested information element. For example, upon receiving a suggested information element, the user can signal their approval, disapproval, or any other response to the information element. The response can then be translated in user feedback data which is used to augment 50 the user's preference model. The user may provide various magnitudes of preference in response to a suggested information element, and the user's preference model may be altered accordingly.

The method 40 may comprise the step of providing 51 the user with organized information elements based on the user's preference model, wherein the information elements are organized such that information elements relevant to the user are more accessible to the user. In one embodiment, the information elements may be provided 51 as an organized list. For example, information elements relevant to the user may be placed on the top of the list. In another embodiment, the information elements may be provided 51 in a graph. For example, information elements relevant to the user may be placed in the center of a graph, and as the nodes move away from the center of the graph, the information elements presented in those nodes are less relevant to the user. The information elements may be organized based on a sliding scale between relevance to the user and information element publication date.

The present invention may also be embodied as a system 59 comprising a server 53, a first 54, second 56, and third 55 database, a processor 57, and a display device 58.

The server 53 is capable of retrieving information elements. In one embodiment, the server 53 scrapes information elements from websites and blogs. In another embodiment, the server 53 may subscribe to information element feeds, such as RSS feeds, in order to retrieve information elements. The server 53 may comprise an information element cleanup module and a natural language pre-processing module. The information element cleanup module may remove unnecessary formatting and HTML markup language from the information elements. The cleanup module may also remove advertisements and other items that are not important to the information element. The natural language pre-processing module may make the information element searchable both to humans and machines. The server 53 may be a single machine, multiple machines, or a cloud-based server.

In one embodiment, each information element is further processed through the natural language pre-processing module that assigns “part-of-speech” tags and identify named entities. Structured information corresponding to each story include, among other attributes, “creation time, source, published time, topic” may be saved in a relational database or similar system. Unstructured information (with natural language pre-processing markings) may be saved as text files on a file system.

The first database 54 may be in electronic communication with the server 53. The first database 54 may comprise attributes associated with each information element. These attributes may be logistic, such as a timestamp and source, or categorical to the content of the information element. The second database 56 may also be in communication with the server 53. The second database 56 may comprise information elements after they have been processed by the cleanup module and natural language pre-processing module. The information elements may be indexed for ease of search. The third database 55 comprises user preference models and associate preference models. At the time of indexing, association to corresponding structured information on the second database 56 may also be maintained. To accomplish this, incremental execution of specific algorithms may be used.

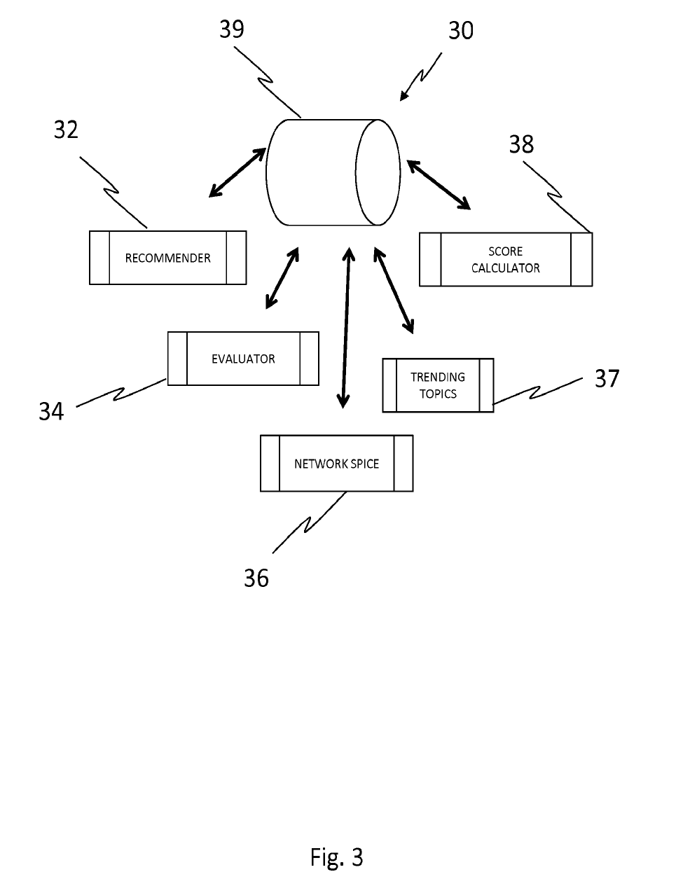

In another embodiment, illustrated in FIG. 3, specific algorithms are run in a scheduler 39. When new content is indexed, an evaluator module 34 calculates an element-specific personalized score for each user based on the user's usage history. A recommender module 32 may continuously monitors a user's likes/dislikes, reading patterns, usage and generates the most active profile for each user. This profile builds up incrementally and the eventually stabilizes. A sudden change in a user's reading behavior may be captured in the profile as a variation that is logged to accommodate change in interests.

In one embodiment, the system may comprise a network spice 36 module which takes into account the influence a user's social network has on his reading habits. This module is responsible for showcasing information elements that can be of “possible interest” to the user based on the interests of his associates in the social network. This module may also run independently and in a scheduler.

In another embodiment, each user may be assigned a score through a scoring module 38. This score determines the strength of a user in terms of his reading habits and his authority in a particular topic. In one example, the higher the score, the better is his authority. The algorithm that computes this score may consider several factors, such as usage, clicks, profile stability, reading behavior, and diversity. This module can be run multiple times a day or week. The timing can be more often or less often depending on the users activity or other criteria. Other modules may include a trending topics module 37. This module is explained in more detail below.

The system may comprise a processor 57 in communication with the first 54, second 56, and third 55 databases. The processor 57 may be configured to evaluate indexed information elements (from the first and second database) based on a user preference model (from the third database), and recommend a subset of the information elements to a user.

The system may comprise a display device 58 in communication with the third database 55 and the processor 57, the device 58 configured to display the subset of the indexed information elements and receive user input for regarding each information element.

The display device 58 may be a personal computer, mobile phone, tablet, or other computing device. The user input may be boolean (e.g., an approve or disapprove rating), textual (e.g., a comment comprising key terms, or natural language sentences), numeric (e.g., a scale from 1 to 10), or any other type of user input. The user input may be sent to the third database 55 where it is used to augment the user and associate preference models.

There may also display a “Breaking News” section that displays current news stories. The system may also include a “Trending Topics” module that can populate the “Breaking News” section. The crawler within this module may monitor public sources of news (e.g., Twitter) for trending search keywords. These trending topics may be used as keywords in order to search the system's information element database 56 and retrieve all the stories associated with these topics are showcased here. The system may be configured to only maintain a specific number of days of stories at any given time on its servers. However data required to compute a user's profile may be maintained as historical data that is erased as soon a profile shift is detected.

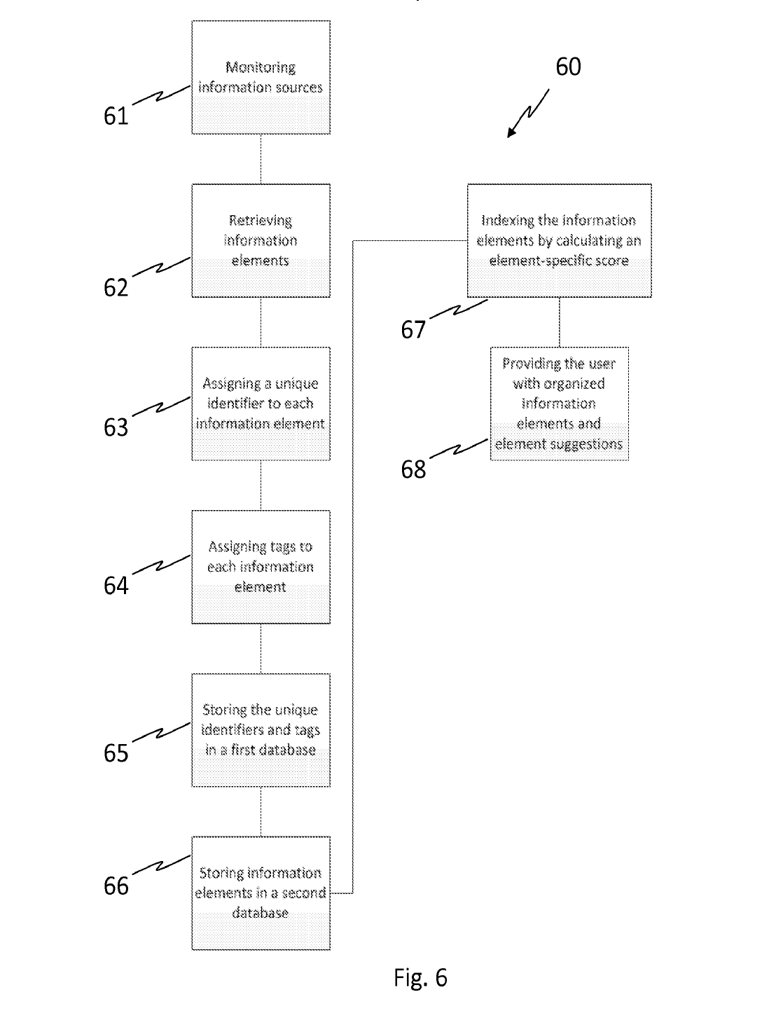

The present invention may also be described as a method for providing a user with organized information elements and information element suggestions. FIG. 6 depicts one embodiment of such a method. In this embodiment, the user may have a user preference model. The method 60 may comprise the step of monitoring 61 information sources that provide information elements. The monitoring may be performed by continually scraping content from the Internet, or by subscribing to periodical update feeds, such as an RSS feed.

When an information elements are detected, the method 60 may comprise the step of retrieving information elements from the information sources. The retrieval 62 may be performed electronically, through a downloading process. The retrieved information element may have, or be associated with a link to the information source from which the information element was retrieved and a timestamp recording when the information element was originally posted, or retrieved by the system. The system may assign 63 a unique identifier to each information element. The unique identifier may be sequential, or the unique identifier may be derived from the information element. For example, each unique identifier may be a hashed output of the information element's link and timestamp.

Tags are then assigned 64 to each information element. As discussed above the tags may be categorical or descriptive regarding the information element. The unique identifiers and the tags associated with each information element may be stored in a first database, while the information elements themselves are stored in a second database.

The method 60 may also comprise the step of indexing 67 the information elements by calculating an element-specific score for the user. The element-specific score may be based on the user's preference model and the tags associated with each information element. The user may be provided 68 with a set of organized information elements and/or information element suggestions based on the calculated element-specific score. In one embodiment, the element-specific score is also based on the user's social network. For example, the scoring algorithm may take the preferences of the user's associates into account. The organized information elements may be provided to the user through a display device such as a computer, tablet, or mobile phone. Instead of being delivered the entire information element, the display device may be provided with unique identifiers for each organized information element such that the display device may retrieving desired information elements from the second database.

Some characteristics of one exemplary system may include: capturing user feedback by monitoring user activity as he consumes information to build a stand-alone user-knowledge preference model; building virtual trusted inner circle network of users based on a category level user-to-user similarity from the existing user's social network; augmenting the user-knowledge preference model by including model parameters discovered from the influence of a user's trusted inner-circle network influencers; triggering the user's information interests by suggesting to him information consumed by his trusted inner circle social peers; organizing available information (on the net) to the user in a way that the user will spend less time searching for relevant information and more time consuming relevant information; augmenting the user-knowledge preference model by extracting features/estimating parameters obtained by monitoring his activity on exclusively shared information items among his social peers. The present system a may make relevant information available to every user in a seamless manner from a huge chunk of data on web.

A reader may be presented information through “pull” and “push” models. The “pull” model focuses on providing the reader with information relevant to his own personalized needs. Looking from the reader's perspective, this model “pulls” from the pool, articles that the reader has explicitly requested for view. The “push” model focuses on showing the reader information that he could be interested in based on the primary influence of the social network he belongs to. Again, looking from the reader's perspective, the “push” model “pushes” to the reader those articles that his friends in the network with similar profiles and information needs are reading.

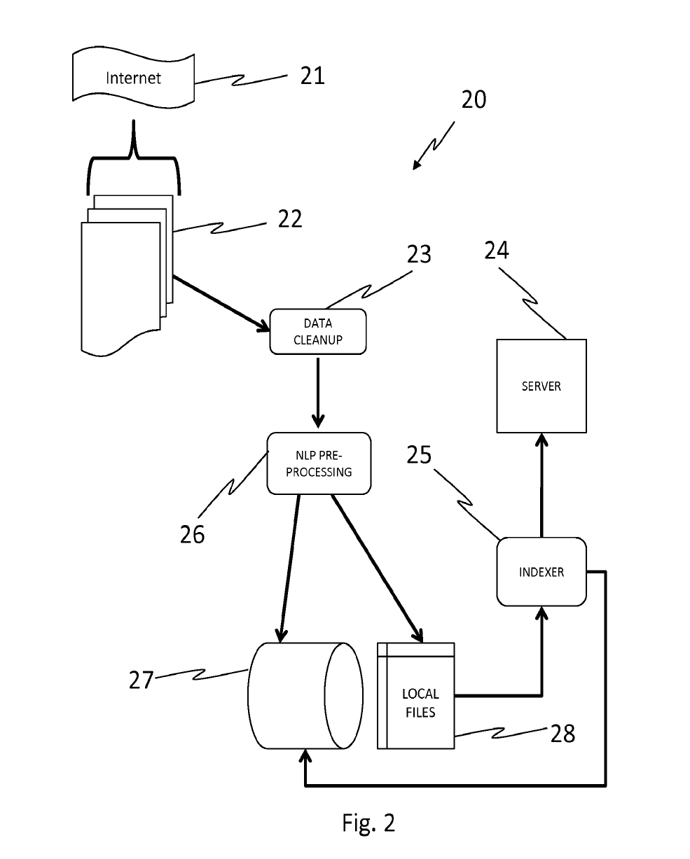

FIG. 2 illustrates a flowchart depicting the retrieval of information elements according to one embodiment of the present invention. Information elements 22 are retrieved from the internet 21 and processed by a data cleanup module 23. After the information elements 22 are processed by the data cleanup module, a natural language pre-processing module 26 separates the files into indexed natural language data (stored in database 27) and raw information elements in database 28. The raw information elements are indexed in an indexer 25 and provided to server 24.

One exemplary embodiment of the invention may be described as having three streams: the reader personalization stream, the network influence stream, and the temporal sensitive stream.

Reader personalization stream. The reader has several options using which he can tune his profile to reflect the information need. The disclosed technology can be a web-based system in which a user creates an account and profile. The reader begins to use the system with a default profile. This profile may be automatically modified over time to accommodate his personalized information. The present invention can have multiple predefined categories, and all existing information element feeds are mapped to at least one of these categories. In one embodiment, six categories are used. The reader first configures his profile by selecting the categories his reading fits into. The reader is also allowed to subscribe to feeds not included in the predefined feed list. But when a new feed is subscribed by the reader, the user may also be required to mention the top level category to which this feed belongs. This manual labeling gives the underlying machine learning algorithm a sense of true topic distribution. Two or more extreme flavors can be included, in which the information is presented to the reader—by relevance, and by time. A slider provided on the profile page may enable the reader to decide the influence of these flavors. The position of the slider decides the extent of influence of each of these flavors with the extreme left end prioritized for relevance and the extreme right end for time.

All of the articles that fall under the categories selected in the profile and are published within the last “n” days may be shown to the reader. When the user starts using the system, the profile has no information needed to configure the relevance. Hence, the slider will be positioned to the extreme right to account only for the temporal influence. The reader may be required to provide the necessary information required to configure personalization in the profile.

Each article may be provided with two selection options for the reader—“thumbs up” and “thumbs down”. The “thumbs up” marking is used by the reader on articles that interest him and would subsequently require more or similar information to be shown. The “thumbs down” marking is used on articles that are completely tangential to his information need. In order to train his profile, the reader is required to mark the articles he reads with either a “thumbs up” or a “thumbs down” sign. If the reader does not mark the article, then the information contained within that article and similar articles are considered to be relevant to the reader's information need but with a very low relevance factor. The articles marked by the reader are used to train a learning model that is based on syntactic and semantic coherence. Incoming new articles are classified based on similarity into three or more categories—relevant, not relevant and neutral. If the slider is set to prioritize relevance, then the relevant articles are shown first followed by neutral and tailed by not relevant ones with each set filtered by day. The profile is incrementally modified to reflect the reader's information change. This learning in our technology is based on the “pull” model where a user pulls down information based on his interests.

Network Influence stream. The reader may be given the option to create his own network. The motivation here is to provide the reader with information that other readers with similar interests are reading. The interest overlap is decided based on the profile matching algorithm. The readers with similar interests are recommended to the reader for him to add to his network. The reader is also shown the tag cloud (or similar profile information) of each recommended reader. Based on the interest overlap, the reader can send a request to the recommended reader if he chooses to add him to his network. The recommended reader can choose to accept the request or not based on his discretion. If the recommended reader accepts the request, he is added to the social network of the requester. The reader can also search for other readers using identification credentials and explicitly send a friend request. The network of a reader can be considered as a network of friends who share similar information need, who's information need awakens the reader's curiosity, or who shared articles are simply a must read by the reader. These factors can be further customized

In one embodiment, the system and method utilizes the “push” model. The articles in the network can be shared explicitly or implicitly. If a reader finds an article particularly interesting, he can share this article explicitly to the network. A relevance score is assigned to the shared article if it falls in the interest category of the reader in the social network (the reader can override this and view all the shared articles). A network influence score is assigned to every incoming new article based on the popularity of the implicit topic of the article and the likeliness of the article to be read by the readers in the network. The impact of network influence on the articles of the reader can be controlled to either include the influence or not.

Temporal sensitive stream. Information is time sensitive. But ordering articles as per time alone may not be sufficient. A time sensitive algorithm implemented in the present invention may consider: the influence of the source of the feed, the importance of the information element, the time of publication of the information element, and other factors. Influence of the source that generates the article is important. Several sources may hold articles containing the same information and published around the same time. One embodiment of the present invention gives priority to those articles released by sources that the reader often reads from. This is learned over time based on the reader's activity with our technology. To facilitate this learning, each source is assigned a prior score based on the articles explicitly marked by the reader with the “thumbs up” and “thumbs down” markings. These scores are recalibrated over time by monitoring the reader's reading activity on our technology. The importance of an article may be decided by how many sources replicate this story and how many readers read it (likely to read) in the network. The present invention may organize all the importance articles with similar topic information to occur together in the view.

Both the source score as well as the importance score account for the time information and articles are ranked as per a final temporal score. The extent to which this score affects the reader's relevant list may be adjusted using a slider.

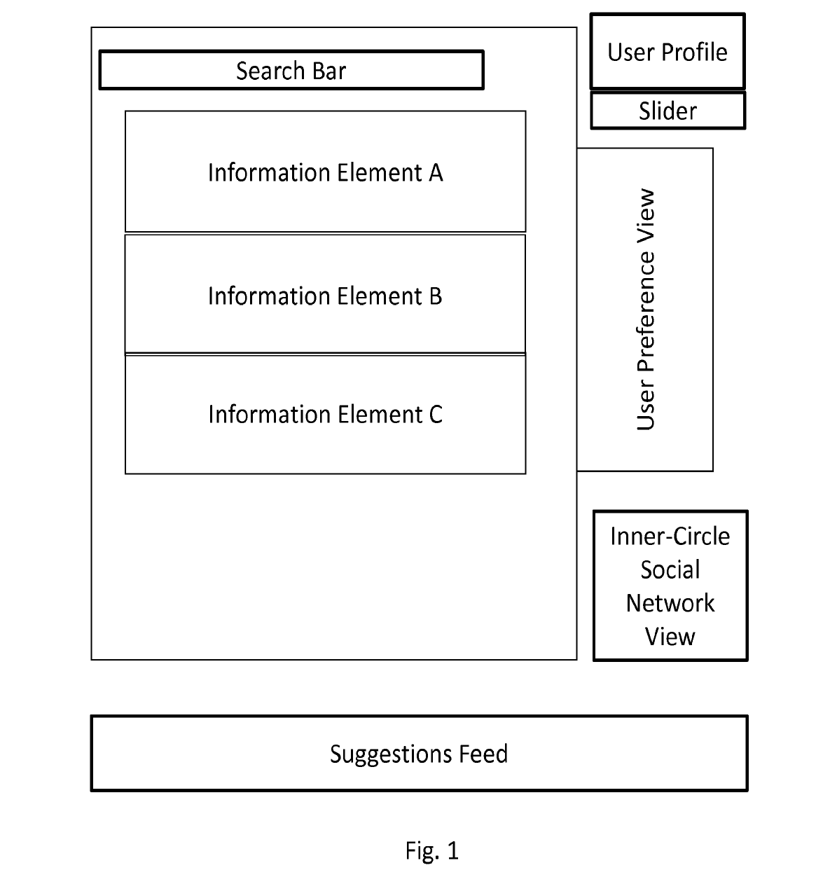

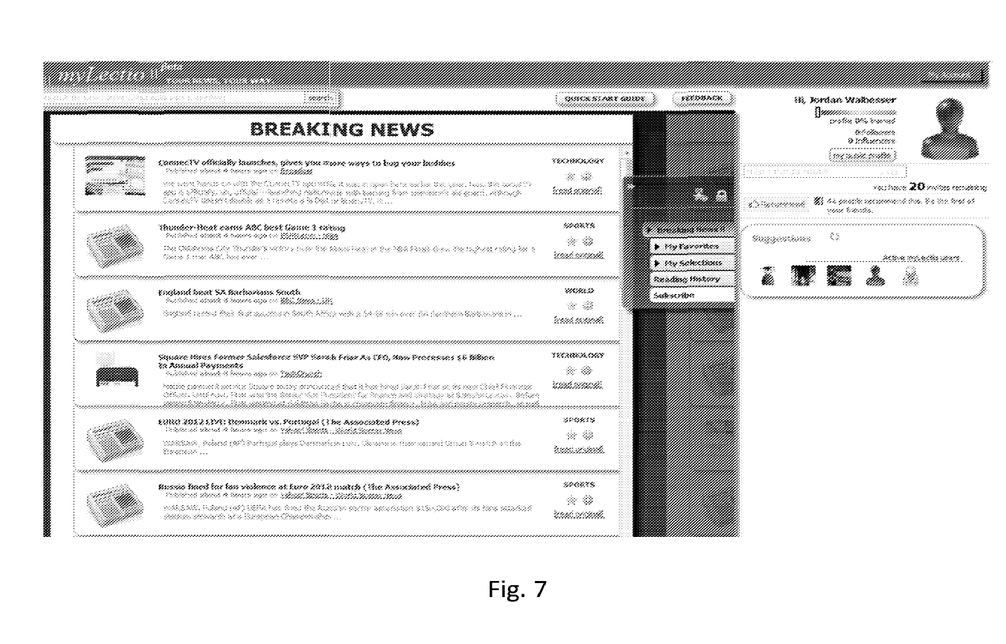

FIGS. 1 and 7 depict layouts of an information element viewing screen according to separate embodiments of the present invention. The present invention may also include a visual representation for a profile. The user can be shown the tag cloud of words to give him an idea of how his profile is built. The reader can use this tag cloud in many ways to tune his profile. For example, if the tag cloud reflects a topic that the reader chooses to filter out of his information need, he can simply right click the topic word and mark it out. The profile will then be recalibrated to negate the relevance scores of articles that cluster to this topic.

In another embodiment, the major functionalities of the present invention (including, but not limited to, the inner circle discovery algorithm, collecting user preferences, providing suitable recommendations, and providing suggestions to expose new information) are well separated and may be provided as APIs. These APIs can be easily plugged into other information consuming channels. As a part of modeling and understanding user preference, the present invention may have a dashboard that monitors users' activity. User statistics may be computed using data stored in a nosql database. Other types of databases that ensure large data retention and quick extraction are preferred. Activities that require continuous user screen updates come may be transmitted from an SQL database engine. In one embodiment, a server may hold multiple instances of a web-version of the present invention. Each instance may catering to its own set of users and databases. Interaction with instances may be completely isolated and data abstraction and isolation are well maintained. Furthermore, each instance of the present invention may have its own UI interface.

The present invention may be used to enable teachers and students share relevant information. Teachers may have their own network and students may have their own network. In some embodiments, these two networks may intersect. For example, if school teachers in a particular region use the system, the teachers of good schools may begin to influence the reading of teachers of poor schools. In this way, the teachers may share relevant information between themselves explicitly and implicitly, thereby creating a platform where teachers become better equipped. In another example, the present invention may be used as a knowledge sharing tool between students to share real time, relevant information. Students can also boast about their reading and the knowledge that they have discovered among their peers through providing a scoring feature that we provide. This concept of gamification may promote additional reading.

Although the present invention has been described with respect to one or more particular embodiments, it will be understood that other embodiments of the present invention may be made without departing from the spirit and scope of the present invention. Hence, the present invention is deemed limited only by the appended claims and the reasonable interpretation thereof.

What is claimed is:

1. A method for providing a user with organized information elements, the user having a social network comprising a plurality of associates, each associate having an associate preference model comprising a plurality of subject categories, the method comprising the steps of:
capturing user feedback data by monitoring the user's activity;
creating a user preference model based on the user's feedback data, the user preference model comprising a plurality of subject categories;
comparing the subject categories of at least one associate preference model to the subject categories of the user preference model;
creating an inner-circle social network, based on the comparison of subject categories, the inner-circle social network comprising one or more of the associates;
augmenting the user preference model based on the associate preference models from the inner-circle social network;
providing the user with suggested information elements based on information elements consumed by associates in the inner-circle social network;
augmenting the user preference model based on the user's response with respect to each suggested information element;
organizing at least some of the information elements based on the user's preference model, wherein the information elements are organized such that information elements relevant to the user are more accessible to the user; and
providing the user with the organized information elements.

2. The method of claim 1, wherein the step of creating a user preference model further comprises the sub-steps of:
creating a default user preference model; and
augmenting the default user preference model based on the monitored user activity.

3. The method of claim 1, further comprising the step of mapping information elements to one or more of the subject categories.

4. The method of claim 3, wherein the step of mapping information elements further comprises the sub-step of receiving from the user a selection of one or more subject categories to which information elements should be mapped.

5. The method of claim 1, wherein the information elements are also organized based on a relevance of each information element to the user and a publication date for each information element, wherein the weight given to the relevance and publication date are adjustable.

6. The method of claim 1, further comprising the step of receiving, from the user, and indication of the relevance of one or more information element.

7. The method of claim 1, further comprising the steps of:
adding an associate to the user's social network; and
augmenting the user's preference model based on the associate preference model of the added associate.

8. A system comprising:
a server capable of retrieving information elements, the servers comprising an information element cleanup module and a natural language pre-processing module;
a first database in communication with the server, the first database comprising attributes associated with each information element;
a second database in communication with the server, the second database comprising indexed information elements transformed by the natural language pre-processing module;
a third database in communication with the server and comprising user preference models;
a processor in communication with the first, second, and third databases, the processor configured to evaluate indexed information elements based on a user preference model in the third database and determine a subset of the information elements relevant to a user based on the evaluation; and
a client device in communication with the third database and the processor, the client device configured to receive the determined subset of information elements from the processor, display the subset, and receive user input regarding each information element of the subset.

9. The system of claim 8, wherein the server is a cloud-based virtual server.

10. The system of claim 8, wherein the device is a mobile device.

11. A method for providing a user with organized information elements and information element suggestions, the user having a user preference model, the method comprising the steps of:
monitoring information sources that provide information elements;
retrieving one or more information elements from the information sources, each retrieved information element having a link and a timestamp;
assigning a unique identifier to each information element, each unique identifier being a hashed output of the information element's link and timestamp;
assigning one or more tags to each information element;
storing the unique identifier and the one or more tags assigned to each information element in a first database;
storing the information elements in a second database, the information elements accessible by the unique identifier;
calculating a user-specific score for each information element, the element-specific score based on the user's preference model and the tags assigned to each information element; and
providing the user with organized information elements and information element suggestions based on the element-specific score calculated for each information element.

12. The method of claim 11, wherein the user has a social network and the element-specific score for the user is also based on the user's social network.

13. The method of claim 11, wherein the organized information elements are provided to a display device.

14. The method of claim 13, wherein the display device is provided with unique identifiers for organized information elements such that the display device is capable of retrieving the information elements from the second database.

15. A system comprising:
a processor configured to retrieve information elements;
an information element cleanup module in communication with the processor;
a natural language pre-processing module, in communication with the processor;
a database in communication with the processor, the database comprising attributes associated with each information element, indexed information elements processed by the natural language pre-processing module, and user preference modules; and
a client device in communication with the database and the processor,
wherein the processor is configured to evaluate indexed information elements based on a user preference model and determine a subset of the information elements relevant to a user based on the evaluation; and
wherein the client device is configured to receive the determined subset of information elements, display the subset of information elements, and receive user input regarding each information element of the subset.
